(19) United States
(12) Patent Application Publication
(10) Pub. No.: US 2003/0028308 A1
(43) Pub. Date: Feb. 6, 2003

(54) Anti-skid brake control

(75) Inventors: Atsushi Ishikawa, Kanagawa (JP); Gen Inoue, Kanagawa (JP); Nobuyuki Ohtsu, Kanagawa (JP)

Correspondence Address: FOLEY AND LARDNER, SUITE 500, 3000 K STREET NW, WASHINGTON, DC, 20007, US

(73) Assignee: UNISIA JECS CORPORATION

(21) Appl. No.: 10/186,743

(22) Filed: Jul. 2, 2002

(30) Foreign Application Priority Data
Jul. 2, 2001 (JP) 2001-200956

(51) Int. Cl. B60T 8/32

(52) U.S. Cl. 701/71; 701/73; 303/121

(57) ABSTRACT

In a brake control apparatus for a vehicle, a left and right road friction coefficient estimating section calculates each of left and right estimated road surface friction coefficients from a relation between a pressure decrease control time in one cycle and a maximum wheel acceleration during the pressure decrease time. A split friction discriminating section discriminates a split friction road surface condition from a non-split condition in accordance with a difference between the left and right estimated road surface friction coefficients. A control modifying section modifies a brake fluid pressure control for a wheel cylinder to differentiate brake control characteristics for left and right wheels from each other in the case of the split friction road surface condition.

### BACKGROUND OF THE INVENTION

The present invention relates to a brake control apparatus and/or method for preventing wheel locking in a vehicle, and more specifically to technique for discrimination and control on a left and right split friction road surface.

An anti-skid brake control system in one approach is arranged to first start the pressure decrease control upon the detection of a slipping condition of a wheel on a lower friction side, and changes over the brake pressure increase control of a wheel on a higher friction side from a steep pressure increase modes to a gradual pressure increase mode (in a manner of a so-called YMR control).

### SUMMARY OF THE INVENTION

However, the brake control of the above-mentioned type is effective only in the first control cycle. When the vehicle enters a left and right split friction road surface during the anti-skid brake control operation, this control system is not necessarily effective. The brake fluid pressure control is carried out in accordance with the vehicle body deceleration in the second and subsequent control cycles, so that the brake control tends to be excessive in the pressure decrease on the higher friction side and excessive in the pressure increase on the lower friction side.

According to one aspect of the present invention, a brake control apparatus comprises: a master cylinder to produce a brake fluid pressure; brake cylinders each to produce a braking force for one of wheels of a vehicle by receiving supply of the fluid pressure; a switch control section to regulate a brake fluid pressure for each brake cylinder in one of a pressure decrease control state to decrease the brake fluid pressure, a pressure hold control state to hold the fluid pressure and a pressure increase control state to increase the brake fluid pressure; a wheel speed sensing section to sense actual wheel speeds of the wheels of the vehicle; a pseudo body speed calculating section to calculate a pseudo vehicle body speed from the wheel speeds sensed by the wheel speed sensing section; a control target speed calculating section to calculate a control target wheel speed in accordance with the pseudo vehicle body speed; a wheel acceleration calculating section to calculate wheel accelerations of the wheels from the actual wheel speeds sensed by the wheel speed sensing section; a pressure control section to control the brake fluid pressure for each brake cylinder in a pressure decrease control by changing over the switch control unit to the pressure decrease control state when the actual wheel speed becomes lower than the control target wheel speed, and in a pressure increase control by changing over the switch control unit to the pressure increase control state when the wheel acceleration is in a predetermined region; a left and right road friction coefficient estimating section to calculate each of left and right estimated road surface friction coefficients from a relation between a pressure decrease control time in one cycle and a maximum wheel acceleration during the pressure decrease time; a split friction discriminating section to discriminate a split friction road surface condition in accordance with a difference between the left and right estimated road surface friction coefficients; and a control modifying section to modify a brake fluid pressure control of the pressure control section to differentiate brake control characteristics for left and right wheels from each other in the case of the split friction road surface condition.

According to another aspect of the present invention, a brake control method comprises: a first step of sensing actual wheel speeds of the wheels of the vehicle; a second step of calculating a pseudo vehicle body speed from the wheel speeds sensed by the wheel speed sensing section; a third step of calculating a control target wheel speed to achieve a desired wheel slip rate in accordance with the pseudo vehicle body speed; a fourth step of calculating wheel accelerations of the wheels from the actual wheel speeds sensed by the wheel speed sensing section; a fifth step of controlling the brake fluid pressure for each brake cylinder in a pressure decrease control by changing over the switch control unit to the pressure decrease control state when the actual wheel speed becomes lower than the control target wheel speed, and in a pressure increase control by changing over the switch control unit to the pressure increase control state when the wheel acceleration is in a predetermined region; a sixth step of calculating each of left and right estimated friction coefficients in accordance with a pressure decrease control time in one cycle and a maximum wheel acceleration during the pressure decrease time; a seventh step of discriminating a split friction road surface condition in accordance with a difference between the left and right estimated friction coefficients; and an eighth step of modifying a pressure control in the fifth control method element to differentiate brake control characteristics on left and right sides from each other in the case of the split friction road surface condition.

The other objects and features of this invention will become understood from the following description with reference to the accompanying drawings.

### BRIEF DESCRIPTION OF DRAWINGS

FIG. 1 is a schematic view of a vehicle equipped with an anti-skid brake control apparatus according to one embodiment of the present invention.

FIG. 2 is a diagram of a brake fluid pressure hydraulic circuit in the anti-skid brake control apparatus of FIG. 1.

FIG. 3 is a flowchart showing a basic control process performed by an ECU in the anti-skid brake control apparatus of FIG. 1.

FIG. 4 is a flowchart showing the calculation of a pseudo vehicle body speed in the control process of FIG. 3.

FIG. 5 is a flowchart showing the calculation of a vehicle body deceleration in the control process of FIG. 3.

FIG. 6 is a flowchart showing the process of left and right split friction discrimination and control in the control process of FIG. 3.

FIG. 7 is a flowchart showing the calculation of a control target speed in the control process of FIG. 3.

FIG. 8 is a flowchart showing the process of PI control in the control process of FIG. 3.

FIG. 9 is a flowchart of a pressure decrease control in the control process of FIG. 3.

FIG. 10 is a flowchart of a pressure increase control in the control process of FIG. 3.

FIG. 11 is a time chart illustrating the discrimination of left and right split friction in the control process of FIG. 3.

FIG. 12 is a time chart illustrating the corrective control in the case of the left and right split friction condition in the control process of FIG. 3.

### DETAILED DESCRIPTION OF THE INVENTION

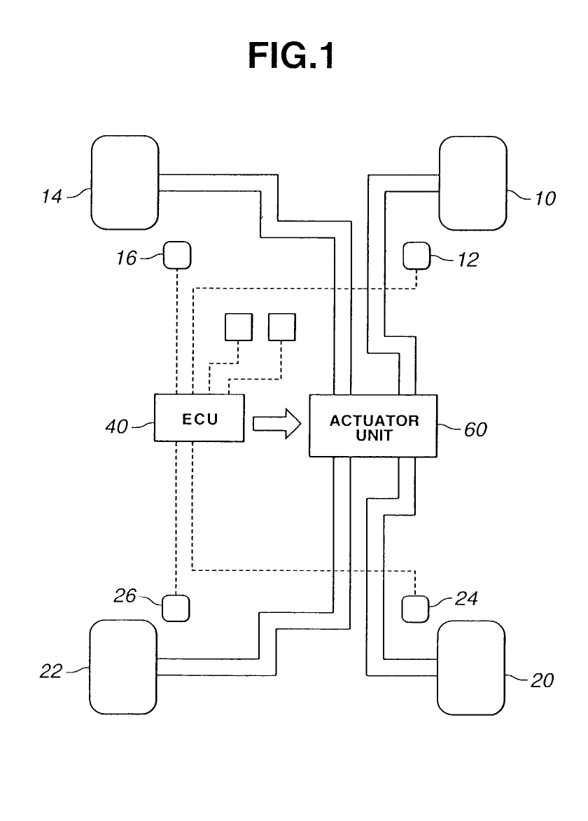

FIG. 1 shows a vehicle equipped with an anti-skid brake control apparatus (or wheel slip brake control apparatus) according to one embodiment of the present invention.

Front wheel speed sensors 12 and 16 (wheel speed sensing means), respectively, sense wheel rotation of right and left front wheels 10 and 14 and produce respective wheel speed pulse signals. In this example, front wheels 10 and 14 are driven wheels not powered by a prime mover, and steerable wheels. Rear wheel speed sensors 24 and 26 (wheel speed sensing section), respectively, sense wheel rotation of right and left rear wheels 20 and 24 and produce respective wheel speed pulse signals. These wheel sensors are connected to a control unit or ECU 40 including a microcomputer (CPU).

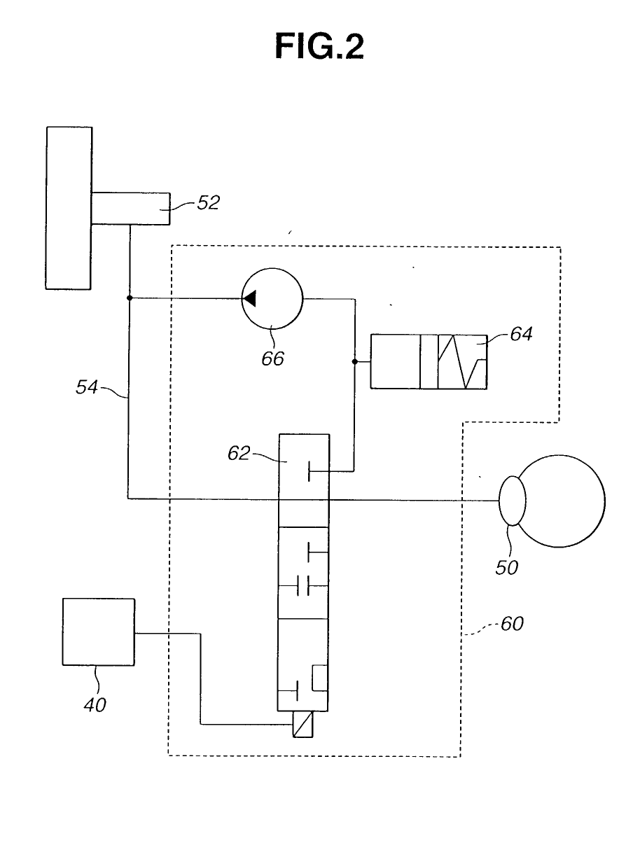

FIG. 2 shows a brake fluid pressure hydraulic circuit (for one wheel only). A wheel cylinder (brake cylinder) 50 (for each wheel) is connected by a main fluid passage 54 with a master cylinder 52 for producing a brake fluid pressure in response to a driver's brake input operation on a brake pedal. An actuator unit 60 for controlling the fluid pressure for wheel cylinder 50 is disposed in main passage 54 between master cylinder 52 and wheel cylinder 50. Though FIG. 2 shows only one brake fluid circuit for only one wheel for simplification, the master cylinder 52 is connected with two separate circuits, one being connected to the wheel cylinders 50 of front right wheel 10 and rear left wheel 22, and the other being connected to the wheel cylinders 50 of front left wheel 14 and rear right wheel 20.

Actuator unit 60 shown in FIG. 2 includes a selector valve 62, a reservoir 64 and a fluid pressure pump 66. Selector valve 62 controls the change-over between pressure increase and pressure decrease in wheel cylinder 50. Reservoir 64 stores the brake fluid in the pressure decrease mode of wheel cylinder 50. Pump 66 functions to return the brake fluid from reservoir 64 to main passage 54. Reservoirs 64 are provided, respectively, for the two separate brake circuits. Selector valve 62 of actuator unit 60 can serve as a switch control section to regulate the brake fluid pressure.

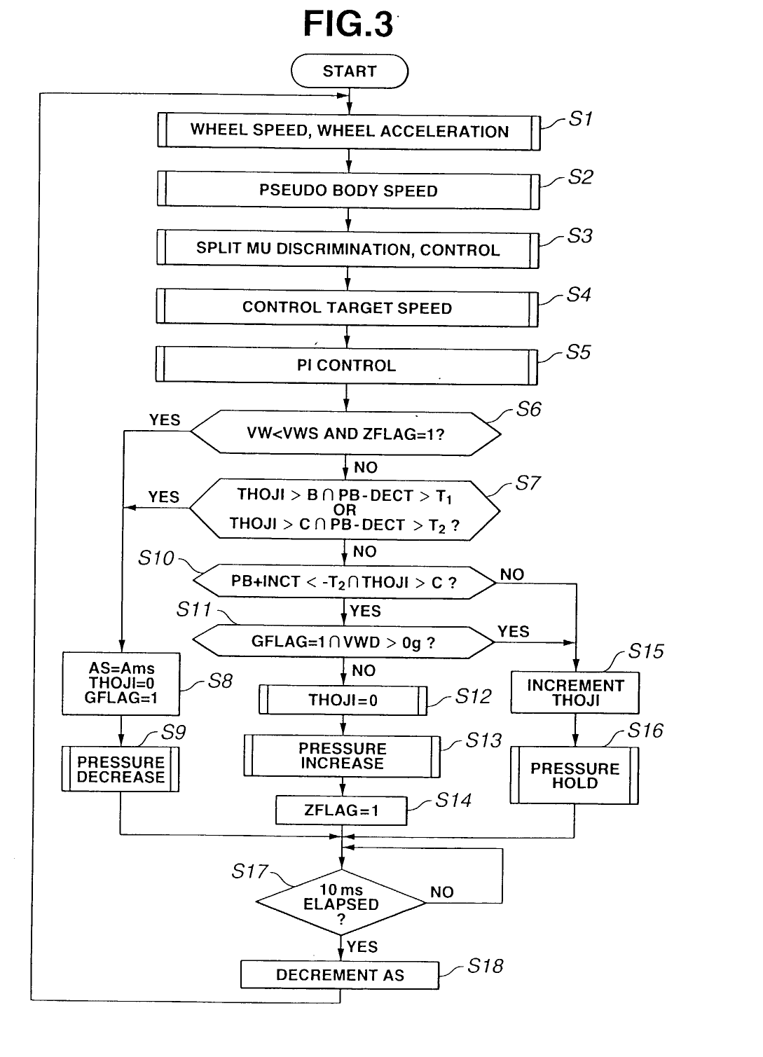

FIG. 3 shows a base control flow of the anti-skid brake control in ECU 40.

Step S1 calculates a wheel speed VW of each of the front right and left wheels 10 and 14 and rear right and left wheels 20 and 24 from wheel speed signals supplied from wheel speed sensors 12, 16, 24 and 26, and further calculates a wheel accelerations VWD of each wheel by differentiation of the wheel speed VW. At least part of step S1 can correspond to a wheel acceleration calculating section.

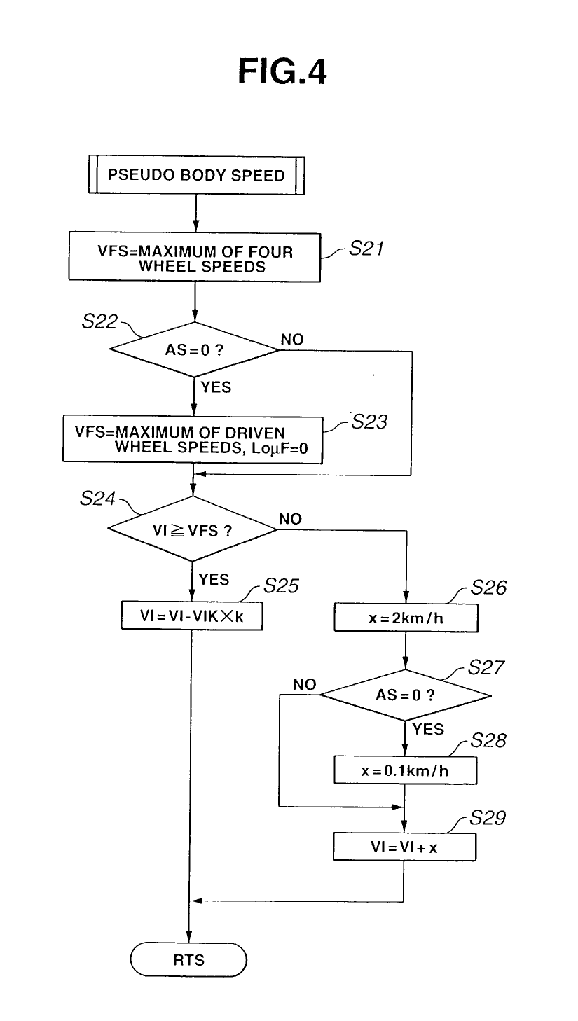

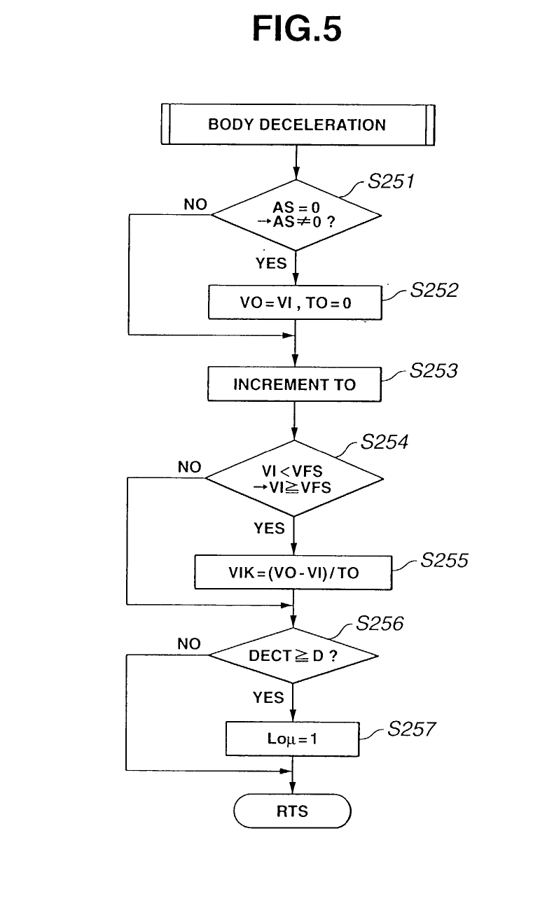

Step S2 following step S1 calculates a pseudo vehicle speed or a pseudo vehicle body speed VI in accordance with wheel speeds VW determined at step S1. The calculation of pseudo body speed VI is shown more in detail in FIGS. 4 and 5. Step S2 corresponds to a pseudo vehicle body speed calculating section.

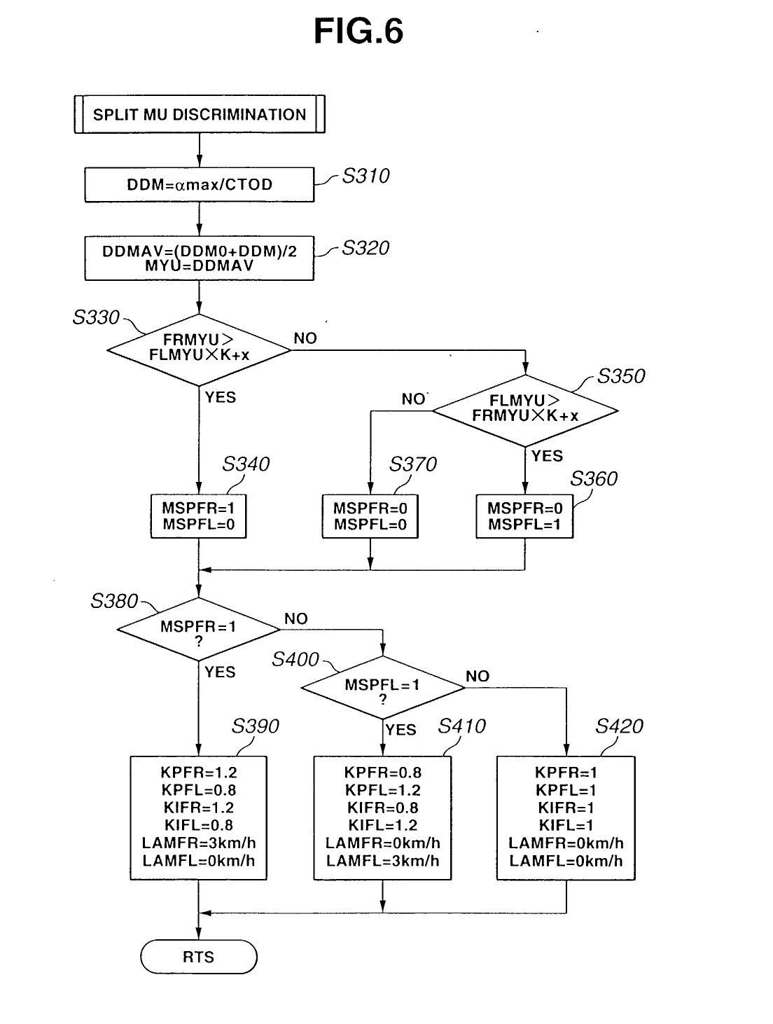

Step S3 discriminates a left and right split mu road surface condition or split friction road surface condition, and performs a control action in accordance with the result of the discrimination. The left and right split mu condition is a condition in which one of the left and right side of the vehicle is on a first friction surface and the other side is on a second friction surface having a friction coefficient (μ) different from that of the first friction surface. The condition discrimination of the split friction and the resulting control are shown more in detail in FIG. 6.

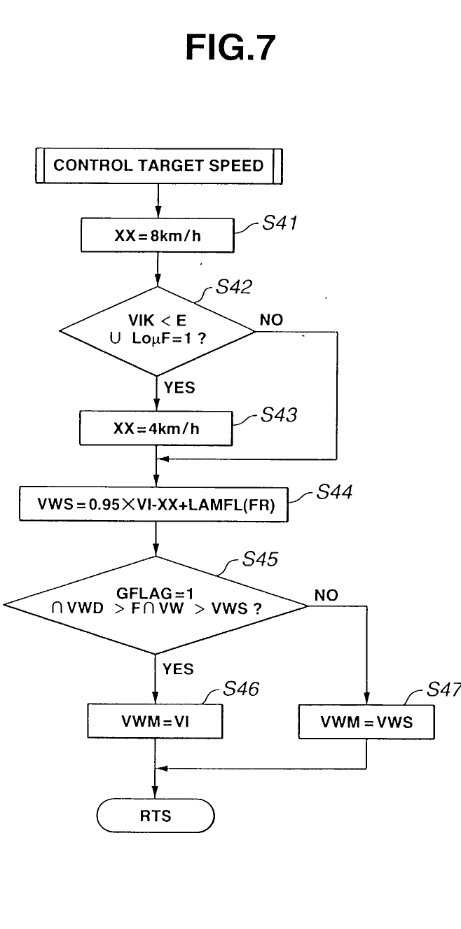

Step S4 calculates a control target speed (a threshold for the pressure decrease judgment) VWS from pseudo body speed VI determined at step S2. FIG. 7 shows more in detail the calculation of control target speed VWS. Step S4 corresponds to a control target speed calculating section.

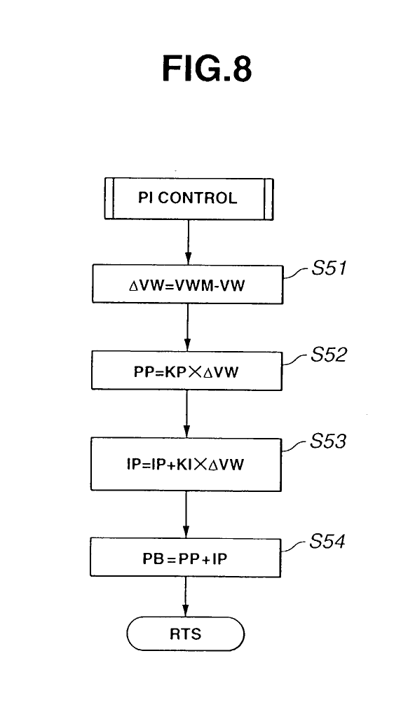

Step S5 performs a PI control process. In this example, step S5 calculates a target pressure increase·decrease pulse time PB representing a target pressure increase·decrease control time of the target brake fluid pressure. FIG. 8 shows more in detail the PI control process.

Step S6 examines whether or not the wheel speed VW of each wheel determined at step S1 is lower than the control target speed VWS determined at step S4, and a pressure increase execution flag ZFLAG is set to one. This pressure increase execution flag ZFLAG is a condition code indicating that the pressure increase control is in progress. If VW<VWS and ZFLAG=1, and hence the answer of step S6 is YES, then the program proceeds to step S8, to perform a brake pressure decrease control.

Step S8 performs a first setting operation to set a pressure decrease control duration AS to a predetermined time A ms, a second setting operation to reset a pressure hold control duration THOJI to zero, and a third setting operation to set a pressure decrease execution flag GFLAG to one. After step S8; the program proceeds to a step S9 to perform the brake pressure decrease control.

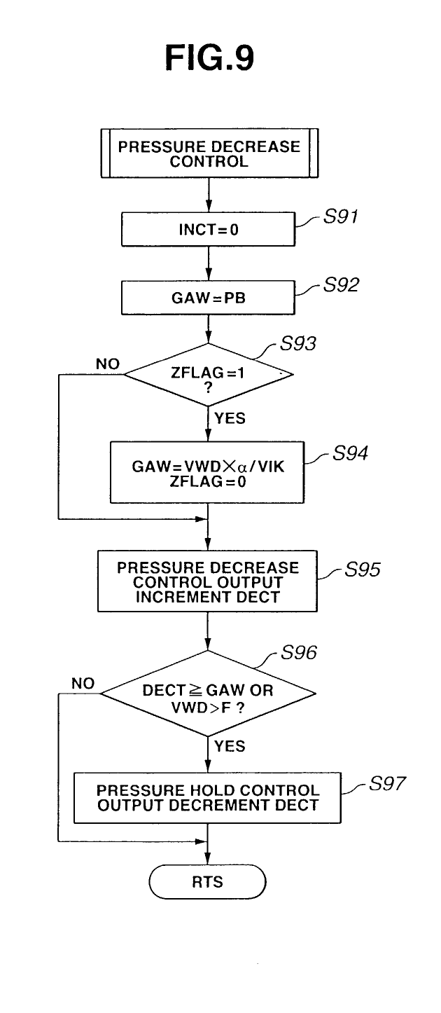

Step S9 performs the brake pressure decrease control. In this example, ECU 40 delivers a change-over signal to selector valve 62 of actuator unit 60, and thereby connects master cylinder 52, the wheel cylinder 50 under the control, and reservoir 64 together. Selector valve 62 is thus put in a pressure increase control state. FIG. 9 shows more in detail the pressure decrease control.

Step S7 is reached from step S6 if VW≧VWS or ZFLAG=0, and hence the answer of step S6 is NO. Step S7 determines whether the brake pressure decrease control is needed or not. In this example, ECU 40 determines whether the pressure hold control duration THOJI is greater than a predetermined time B ms (THOJI>B), and the difference (PB−DECT) resulting from subtraction from the target pressure increase·decrease pulse duration PB, of a pressure decrease time timer DECT is greater than a predetermined time T1 ms (PB−DECT>T1), or whether the pressure hold control duration THOJI is greater than a predetermined time C ms which is greater than the time B (B<C) (THOJI>C), and the difference (PB−DECT) resulting from subtraction from the target pressure increase·decrease pulse time PB, of the pressure decrease time timer DECT is greater than a predetermined time T2 ms (T2<T1)(PB−DECT>T2). If either of these conditions is met, and the answer of step S7 is YES, then the program assumes that the pressure decrease control is needed, and hence proceeds to step S8.

Step S10 is reached from step S7 for further check on the need of the pressure increase control or the pressure hold control if neither of these two conditions are satisfied, and hence the answer of step S7 is NO. Step S10 is for determining whether the pressure increase control is needed. In this example, step S10 checks a first condition which is satisfied when the sum of the target pressure increase·decrease pulse time PB and the pressure increase timer INCT is smaller than a predetermined time −T2 ms, and a second condition which is satisfied when the pressure hold control time THOJI is greater than a predetermined time C ms (THOJI>C). If the first and second conditions are both satisfied, and hence the answer of step S10 is YES, then the program proceeds to step S11 on the assumption that the wheel is not yet in a slipping condition.

Step S11 checks a first condition which is satisfied when the pressure decrease execution flat GFLAG (for indicating the period of the pressure decrease control) is set to one, and a second condition which is satisfied when the wheel acceleration VWD is greater than 0 g. If either or both of these first and second conditions is not satisfied, and the answer of step S11 is NO, then the program assumes that the fluid pressure of wheel cylinder 50 tends to be insufficient, and proceeds to a step S12 to reset pressure hold control time THOJI to zero. After step S12, step S13 is reached for carrying out the pressure increase control.

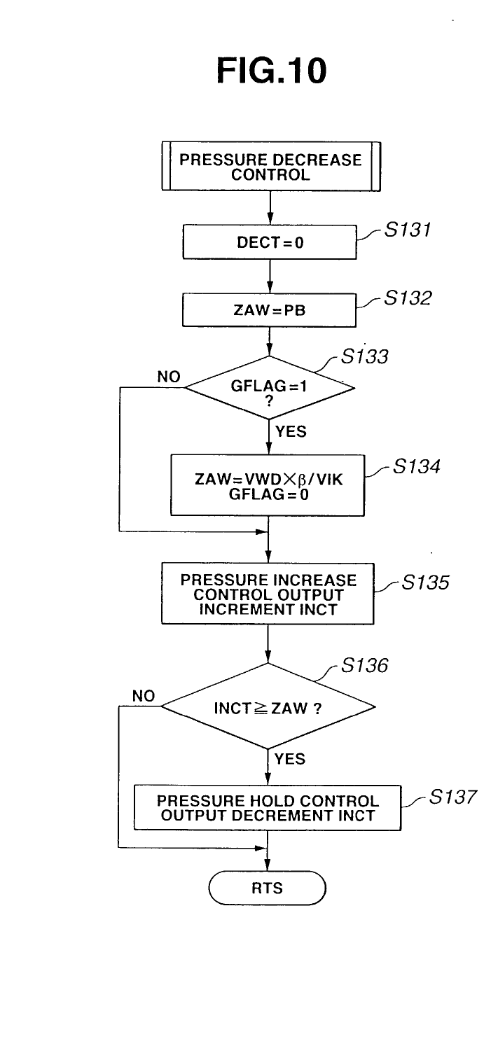

Step S13 performs the pressure increase control. In this example, selector valve 62 in actuator valve 60 is switched to a pressure increase control state connecting master cylinder 52 and wheel cylinder 50. FIG. 10 shows more in detail the pressure increase control. After step S13, step S14 sets pressure increase execution flag ZFLAG to one (ZFLAG=1).

Step S15 is reached from step S10 if the answer of step S10 is NO, or from step S11 if the answer of step S11 is YES. The answer of step S10 is NO when PB+INCT≧−T2 ms or THOJI≦C ms. The answer of step S11 is YES when GFLAG=1 and VWD>0. Step S15 increments pressure hold control time THOJI. After step S15, the program proceeds to step S16 for the pressure hold control.

Step S16 carries out the brake fluid pressure hold control. In this example, selector valve 62 is switched to a pressure hold state shutting off wheel cylinder 50 from master cylinder 52 and from reservoir 64.

Step S17 is reached after one of steps S9, S14 and S16. Step S17 checks whether a period of 10 ms has elapsed. The program repeats step S17 if the elapsed time is smaller 10 ms (NO), and proceeds to next step S18 if the elapsed time is equal to or greater than 10 ms (YES). In this way, this control routine is carried out at regular time intervals of 10 ms.

S18 decrements pressure decrease control time AS. Then, the program terminates the control flow of this cycle, and returns to step S1. Steps S9, S13 and S16 can correspond to a pressure control section to control the brake fluid pressure for each brake cylinder.

FIG. 4 shows the pseudo vehicle body speed calculating process of step S2.

Step S21 sets a select-high wheel speed VFS equal to a maximum among the wheel speeds VW of the four wheels. After step S21, the program proceeds to step S22.

Step S22 determines whether pressure decrease control execution time AS is equal to zero or not, to determine whether the system is in a pressure non-decrease control state. When the pressure decrease control is not in progress and the answer of step S22 is YES (AS=0), then the program proceeds to step S23, sets the select-high wheel speed VFS equal to a maximum among the wheel speeds VW of the driven wheels at step S23, and proceeds to step S24. When the pressure decrease control is in progress and the answer of step S22 is NO (AS≠0), then the program proceeds from step S22 directly to step S24.

Step 524 examines whether pseudo vehicle body speed VI is equal to or higher than select-high wheel speed VFS, or not. In the case of YES (VI≧VFS), the program proceeds to step S25, calculates pseudo vehicle body speed VI in the vehicle deceleration by the following equation, and terminates the control flow of this execution cycle.

VI=VI−VIK×k

In this equation, VIK is the deceleration of the vehicle, which is calculated as shown in FIG. 5.

When VI<VFS and hence the answer of step S24 is NO, then the program assumes that the vehicle is in an accelerating state, proceeds to step S26, sets a deceleration limiter constant x equal to 2 km/h, and proceeds to step S27.

Step S27 checks again whether the control system is the pressure non-decrease control, by examining whether pressure decrease control execution time AS is equal to zero or not. In the case of YES (AS=0), the program proceeds to step S28, sets the deceleration limiter constant x equal to 0.1 km/h, and proceeds to step S29. In the case of NO (AS≠0), the program proceeds from step S27 directly to step S29.

Step S29 determines pseudo vehicle body speed VI by the following equation.

VI=VI+x

After step S29, this flow ends.

FIG. 5 shows the calculation of the vehicle body deceleration used in step S25 of FIG. 4.

Step S251 examines whether the control mode is changed from the non-decrease mode (AS=0) to the pressure-decrease mode (AS≠0). From step S251, the program proceeds to step S252 in the case of YES, and proceeds directly to step S253 in the case of NO (AS=0). Step S252 sets a deceleration control start vehicle speed VO which is a vehicle speed at the beginning of the pressure decrease control, to pseudo vehicle body speed (VO=VI), and resets a vehicle deceleration timer TO to zero (T0=0). After step S252, the program proceeds to step S253. Step S253 increments vehicle deceleration timer TO, and then transfers control to step S254.

Step S254 (spin-up judgment) determines whether select-high wheel speed VFS is restored to pseudo vehicle body speed VI. In the case of YES (VI<VFS→VI≧VFS), the program proceeds to step S255, determines vehicle body deceleration VIK by the following equation, and then proceeds to step S256.

VIK=(VO−VI)/TO

When the answer of step S254 is NO (VI<VFS), the program proceeds directly from step S254 to step S256.

Step S256 (low μ road judgment) determines whether the road is a low friction road or not, by examining whether pressure decrease timer DECT is equal to or greater than D ms. In the case of YES (DECT≧D) indicating a low friction road condition, the program proceeds to step S257, sets a low friction flag LouF to one, and terminates this flow. In the case of NO (DECT<D) indicating a high friction road condition, the flow is terminated directly.

FIG. 6 shows the left and right split friction discrimination and resulting control of step S3.

Step S310 determines an estimated road friction coefficient DDM(FL) or DDM(FR) for each of front left wheel 14 and front right wheel 10, from a pressure decrease control timer count CTOD from a start of the pressure decrease control to a start of the pressure increase control, and a maximum wheel acceleration value αmax of the wheel acceleration during the pressure decrease control, by using the following equation.

DDM=αmax/CTOD

Step S320 following step S310 determines an average DDMAV(FL) or DDMAV(FR) of two successive most recent values of the estimated road friction coefficient DDM(FL) or DDM(FR) for front left or right wheels 14 or 10, by using the following equation.

DDMAV=(DDMO+DDM)/2

The thus-determined averages DDMAV(FL) and DDMAV(FR) are used as estimated road surface friction coefficients FLMYU and FRMYU of front left and right wheels 14 and 10 for the left and right split friction discrimination. That is, FLMYU=DDMAV(FL) and FRMYU=DDMAV(FR). Steps S310 and S320 can correspond to a left and right road friction coefficient estimating section.

Step S330 checks the estimated left and right friction coefficients FLMYU and FRMYU, and thereby determines whether the road condition is a first split friction condition with front right wheel 10 on a high mu road surface and front left wheel 14 being on a low mu road surface. In this example, the first split friction condition is affirmed when the right side estimated friction coefficient FRMYU is higher than the left side estimated friction coefficient FLMYU, and the difference between the right side estimated friction coefficient FRMYU and the left side estimated friction coefficient FLMYU is greater than a predetermined value.

FRMYU>FLMYU×K+x

In this expression K is a gain, and x is constant. In the case of YES, the program proceeds to step S340. Step S340 sets a right side higher friction flag MSPFR to one (MSPFR=1), and resets a left side higher friction flag MSPFL to zero (MSPFL=0). After step S340, the program proceeds to step S380.

When the answer of step S330 is NO, the program proceeds to step S350, and checks the estimated left and right friction coefficients FLMYU and FRMYU, to determine whether the road condition is a second split friction condition with front left wheel 14 on a high mu road surface and front right wheel 10 being on a low mu road surface. In this example, the second split friction condition is affirmed when the left side estimated friction coefficient FLMYU is higher than the right side estimated friction coefficient FRMYU, and the difference between the left side estimated friction coefficient FLMYU and the right side estimated friction coefficient FRMYU is greater than a predetermined value.

FLMYU>FRMYU×K+x (K: Gain, x: Constant)

In the case of YES, the program proceeds to step S360. Step S360 resets the right side higher friction flag MSPFR to zero (MSPFR=0), and sets the left side higher friction flag MSPFL to one (MSPFL=1). After step S360, the program proceeds to step S380. In the case of NO, the program proceeds to step S370. Step S370 resets both the right side higher friction flag MSPFR to zero (MSPFR=0) and the left side higher friction flag MSPFR to zero (MSPFL=0), and then transfers control to step S380.

Step S380 checks whether right side high friction flag MSPFR is set to one, or not. In the case of YES (MSPFR=1), the program proceeds to step S390. Step S390 sets a proportional gain KP and an integral gain KI used in the PI control for calculating the target pressure increase·decrease pulse time PB of each wheel, and an additional quantity (threshold raise) LAM used for addition in the calculation of the control target speed VWS. In the case of step S390;

KPFR=1.2

KPFL=0.8

KIFR=1.2

KIFL=0.8

LMFR=3 km/h

LAMFL=0 km/h

Thus, step S390 sets the proportional gain KP and integral gain KI higher (1.2) on the higher friction side for the front right wheel and lower (0.8) on the lower friction side for the front left wheel, and sets the threshold difference LAM higher (3 km/h) on the higher friction side for the front right wheel 10, and lower (0 km/h) on the lower friction side for the front left wheel 14. After step S390, this flow ends. When the answer of step S380 is NO, the program proceeds to step S400.

Step S400 checks whether left side high friction flag MSPFL is set to one, or not. In the case of YES (MSPFL=1), the program proceeds to step S410. Step S410 sets the proportional gain KP and integral gain KI used in the PI control for calculating the target pressure increase/decrease pulse time PB of each wheel, and the additional quantity LAM used for addition in calculation of the control target speed VWS. In the case of step S410;

KPFR=0.8

KPFL=1.2

KIFR=0.8

KIFL=1.2

LAMFR=0 km/h

LAMFL=3 km/h

Thus, step S410 sets the proportional gain KP and integral gain KI higher (1.2) on the higher friction side for the front left wheel 14 and lower (0.8) on the lower friction side for the front right wheel 10, and sets the threshold additional quantity LAM higher (3 km/h) on the higher friction side for the front left wheel 14, and lower (0 km/h) on the lower friction side for the front right wheel 10. After step S390, this flow ends. When the answer of step S380 is NO, the program proceeds to step S400.

When the answer of step S400 is NO (MSPFR=0, MSPFL=0), the program proceeds to step S420, and sets the proportional gain and integral gain to normal values, and the threshold additional quantities LAM to 0 km/h.

KPFR=1

KPFL=1

KIFR=1

KIFL=1

LAMFR=0 km/h

LAMFL=0 km/h

This flow ends after one of steps S390, S410 and S420. At least one of steps S330, S340, S350, S360, S370, S380 and S400 can correspond to a split friction discriminating section to discriminate the split friction road surface condition from a non-split friction road surface condition. At least one of steps S390, S410 and S420 can correspond to a control modifying section to modify the brake fluid pressure control to differentiate the brake control characteristic between the left side and right side wheels in the presence of the split friction road surface condition.

FIG. 7 shows the calculation of the control target speed of step S4.

Step S41 sets an offset quantity XX for control target speed VWS to 8 km/h (XX=8 km/h), and transfer control to step S42.

Step S42 examines whether the road is a low friction road or not, by checking whether the vehicle body deceleration VIK is lower than a predetermined value E (VIK<E), and at the same time the low mu flag LouμF is set to one (LouμF=1). In the case of YES (low friction surface), the program proceeds from step S42 to step S43, sets the offset quantity XX to 4 km/h, and proceeds to step S44. In the case of NO (high friction surface), the program proceeds from step S42 directly to step S44 (so that offset quantity XX remains equal to 8 km/h).

Step S44 calculates control target speed VWS by the use of the following equation in accordance with pseudo vehicle body speed VI calculated by the flow of FIG. 4, the offset quantity XX, and the results of the process of FIG. 6, and thereafter transfers control to step S45.

VWS=0.95×VI−XX+LAMFL(FR)

In this equation, XX is the offset quantity, and LAM is the additional quantity to be added in the left and right split friction state.

Step S45 checks whether the pressure decrease flag GFLAG is set to one, the wheel acceleration VWD exceeds a predetermined value F, and at the same time the wheel speed VW exceeds the control target speed VWS. In the case of YES (GFLAG=1, VWD>F and VW>VWS), the program proceeds to step S46, and sets target slip vehicle speed VWM to pseudo vehicle body speed VI (VWM=VI). In the case of NO, the program proceeds to step S47, sets target slip vehicle speed VWM to control target speed VWS (VWM=VWS), and terminates this flow.

FIG. 8 shows the PI control process of step S5.

Step S51 determines a deviation ΔVW by using the following equation.

ΔVW=VWM−VW

Step S52 determines a proportional term PP for the PI control by using the following equation.

PP=KP×ΔVW (KP: Proportional Gain)

Step S53 determines an integral term IP for the PI control by using the following equation.

IP=IP+KI×ΔVW (KI: Integral Gain)

That is, integral term IP is the sum of the previous value of IP obtained 10 ms before, and the product KI×ΔVW.

Step S54 determines the target pressure increase·decrease pulse time PB by the following equation and then terminates this flow.

PB=PP+IP

FIG. 9 shows the pressure decrease control of step S9.

Step S91 resets the pressure increase time counter INCT to zero (INCT=0), and then next step S92 sets a pressure decrease pulse time GAW to target pressure increase·decrease pulse time PB (GAW=PB), and transfer control to step S93.

Step S93 examines whether pressure increase execution flag ZFLAG is set to one or not. From step S93, the program proceeds to step S94 in the case of YES (ZFLAG=1), and determines pressure decrease pulse time GAW by the following equation.

GAW=VWD×α/VIK (α: Coefficient)

Moreover, step S94 resets pressure increase execution flag ZFLAG to zero, and thereafter transfers control to step S95. In the case of NO (ZFLAG=0), the program proceeds from step S93 directly to step S95.

Step S95 performs a port pressure decrease output operation, and increments pressure decrease timer DECT. After step S95, the program proceeds to step S96.

Step S96 examines whether the pressure decrease timer DECT is equal to or greater than the pressure decrease pulse time GAW, or the wheel acceleration VWD exceeds predetermined value F. In the case of YES (DECT≧GAW, or VWD>F), the program proceeds to step S97 and then terminates this flow. In the case of NO (DECT<GAW and VWD≦F), the program terminates this flow directly. In the case of YES, step S97 performs a pressure hold control output operation and decrements pressure decrease timer DECT.

FIG. 10 shows the pressure increase control of step S13 in FIG. 3.

Step S131 resets pressure decrease timer DECT to zero (DECT=0), and next step S132 sets pressure increase time ZAW to target pressure increase·decrease pulse time PB (ZAW=PB), and then transfers control to step S133.

Step S133 examines whether pressure decrease execution flag GFLAG is set to one, or not. In the case of YES (GFLAG=1), the program proceeds to step S134, and determines pressure increase pulse time ZAW by the following equation.

ZAW=VWD×β/VIK (β: Coefficient)

Moreover, step S134 resets pressure decrease execution flag GFLAG to zero, and then transfers control to step S135. In the case of NO (GFLAG=0), the program proceeds from step S133 directly to step S135.

Step S135 performs a port pressure increase output operation and increments pressure increase timer INCT. Thereafter, the program proceeds to step S136.

Step S136 examines whether pressure increase timer INCT is equal to or greater than pressure increase pulse time ZAW, or not. In the case of YES (INCT≧ZAW), the program proceeds to step S137. Step S137 performs a port pressure hold output operation, and decrements pressure increase timer INCT. After step S137, the program terminates this flow. In the case of NO (INCT<ZAW), the program terminates this flow directly.

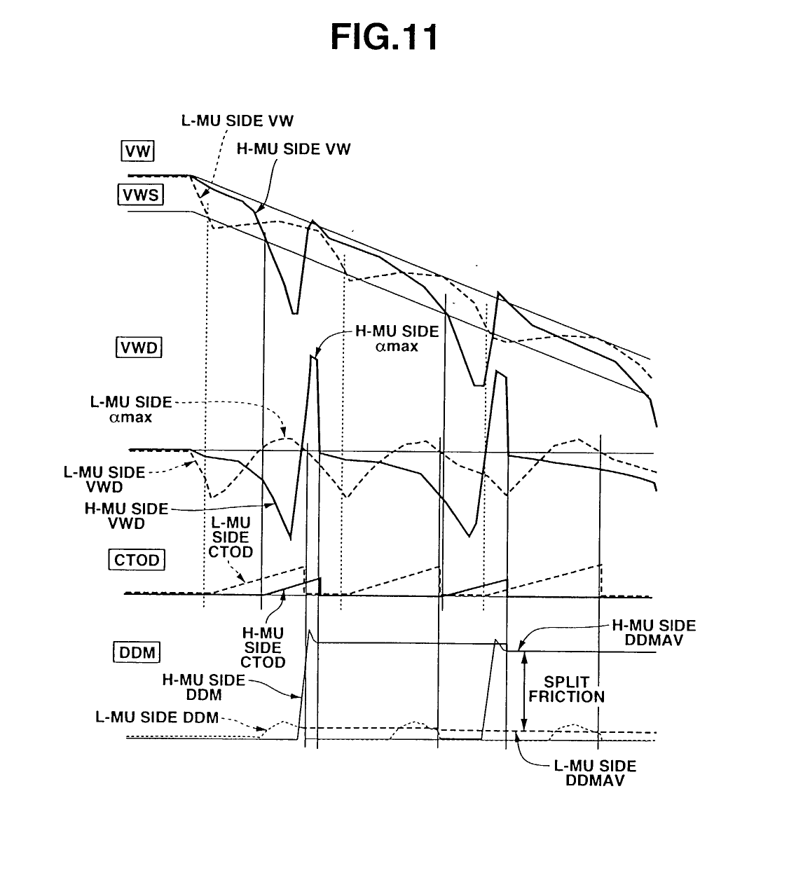

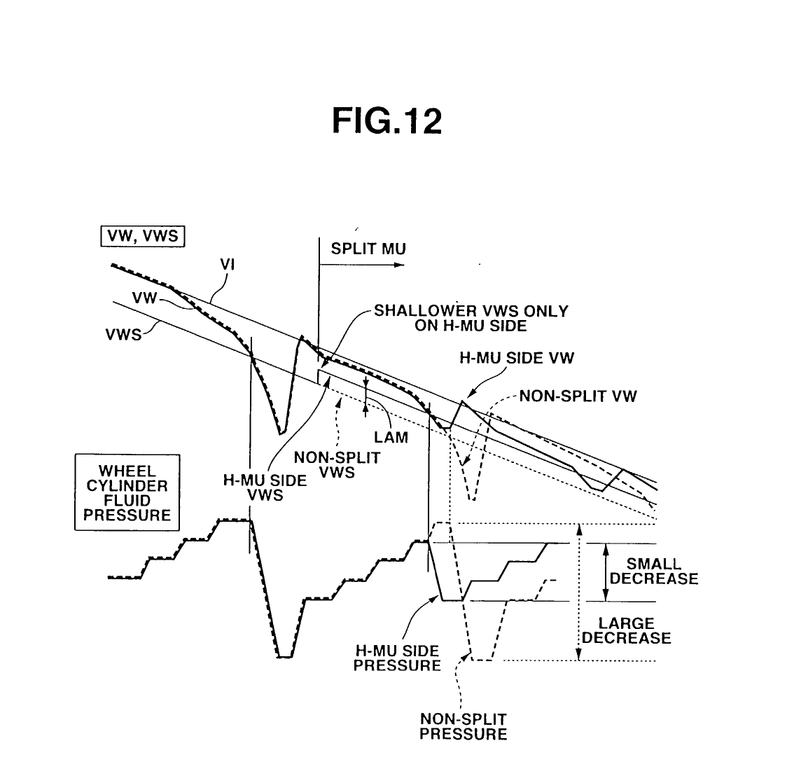

FIGS. 11 and 12 illustrate operations of the thus-constructed anti-skid brake control apparatus according to this embodiment. In these figures, L-MU side and H-MU side stand, respectively, for the low μ side and high μ side in the case of the split friction road surface condition. NON-SPLIT means the condition in which the split friction road surface condition is not detected.

(A) Anti-Skid Base Control

When wheel speed VW becomes lower then control target speed VWS determined from pseudo vehicle body speed VI, ECU 40 recognizes a possibility of wheel locking, and decreases the braking force by the pressure decrease control for the associated wheel cylinder 50 with the selector valve 62 in the pressure decrease control state. With this pressure decrease control, wheel speed VW turns from the decelerating direction to the accelerating direction, and this brake control apparatus or system can prevent wheel locking on braking.

Thereafter, when wheel acceleration VWD becomes lower than or equal to 0 g as the result of the pressure decrease control, ECU 40 changes the brake control to the pressure increase mode by change-over of selector valve 62 to the pressure increase control state, and thereby increase the fluid pressure of the wheel cylinder 50. Thus, this brake control system can prevent lack of vehicle deceleration by increasing the braking force.

(B) Left and Right Split Friction Discrimination

ECU 40, at step S310 of FIG. 6, determines the estimated road surface friction coefficient DDM(FL) or DDM(FR) of each of front left and right wheels 14 and 10, from the pressure decrease control timer count CTOD in one cycle from the instant when the wheel speed decreases below the control target speed and the pressure decrease control is started in response, to the instant when the wheel acceleration VWD becomes lower than or equal to 0 g and hence the pressure increase control is started, and the maximum value αmax of the wheel acceleration VWD of the wheel during the pressure decrease control, as shown in FIG. 11. In this embodiment, ECU 40 determines the final estimated road surface friction coefficients FLMYU and FRMYU of the front left and right wheels 14 and 10, by averaging the thus-determined friction coefficients DDM(FL) and DDM(FR), at step S320 of FIG. 6.

Then, ECU 40 checks left and right road surface friction coefficients FLMYU and FRMYU to determine whether the difference between FLMYU and FRMYU is greater than a predetermined difference value, and which side is higher in the friction coefficient, at steps S330 and S350.

In this way, the brake control system according to this embodiment detects the split mu road surface condition by monitoring the road surface friction coefficient MYU of each of left and right front wheels 14 and 10, estimated by using the relation between the variables CTOD and αmax resulting from the anti-skid brake control operation. Consequently, this brake control system can detect the split friction road surface condition accurately even when the vehicle enters the split friction road surface in the process of the anti-skid brake control operation.

(C) Corrective Control on Split Friction Higher Friction on Right Side

When, in the split friction road surface condition, right front wheel 10 is on a higher friction road surface and left front wheel 14 is on a lower friction road surface, the following correction is made. ECU 40 increases the control gain (KP and KI in this example) in the PI control for determining the target pressure increase·decrease pulse time PB for each wheel, from a normal value (1) to a higher value (1.2) for the right side wheel on the higher friction side, and decreases the control gain from the normal value (1) to a lower value (0.8) for the left side wheel on the lower friction side (at step S390). With this adjustment of the control gain, the brake control system according to this embodiment can avoid the occurrence of excessive pressure decrease and excessive pressure increase in the left and right split road surface friction condition.

Moreover, in this embodiment, the threshold additional quantity LAM is set equal to a higher value of 3 km/h for the right side wheel on the higher friction side, and to a lower value of 0 km/h for the left side wheel on the lower friction side, at step S390 in FIG. 6. This threshold additional quantity LAM is added in the operation to determine control target speed VWS at step S44 of FIG. 7. Therefore, as shown in FIG. 12, this brake control system can decrease the pressure decrease quantity by starting the pressure decrease control earlier even when the slip is relatively shallow or small, and by so doing, prevent an excessive pressure decrease for the right side wheel on the higher friction side. By preventing excessive pressure increase and decrease, this embodiment can improve the control performance in the anti-skid brake control, and contribute to the overall cost reduction by reducing the required capacity of fluid pressure pump motor.

Higher Friction on Left Side

When, in the split friction road surface condition, left front wheel 14 is on a higher friction road surface, the setting is reversed, at step S410 in FIG. 6, between the left and right sides from the setting in the split friction condition with the right side on the higher friction.

Non-Split Condition

In the absence of the left and right split road surface friction condition, the control gain (KP and KI) is set to the normal value (1) and the threshold additional quantity LAM is set to 0 kg/h on both the left and right sides at step 5420.

In the illustrated embodiment, the brake fluid pressure is increased again when the wheel acceleration VWD becomes equal to or lower than 0 g. However, the brake control system may be configured to start the pressure increase control again earlier when the wheel acceleration VWD becomes equal to or higher than a predetermined acceleration value (5 g) so that the pseudo vehicle body speed is formed smoothly.

Instead of adjusting the control gain (KP and KI) and threshold raising additional quantity (LAM) in the case of split friction road surface condition as in the illustrated embodiment, it is optional to increase the coefficient β used in the calculation of pressure increase pulse time ZAW on the higher friction side, and at the same time to increase the coefficient α used in the calculation of pressure decrease pulse time GAW on the lower friction side.

In the illustrated embodiment, the select-high wheel speed VFS is set equal to the highest wheel speed among the wheel speeds of the four wheels. However, it is optional to select, as the select-high wheel speed VFS, a second highest or a third highest wheel speed among the wheel speeds of the four wheels in dependence on vehicle running conditions.

This application is based on a prior Japanese Patent Application No. 2001-200956 filed in Japan on Jul. 2, 2001. The entire contents of the prior Japanese Patent Application No. 2001-200956 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
a master cylinder to produce a brake fluid pressure;
brake cylinders each to produce a braking force for one of wheels of a vehicle by receiving supply of the fluid pressure;
a switch control section to regulate a brake fluid pressure for each brake cylinder in one of a pressure decrease control state to decrease the brake fluid pressure, a pressure hold control state to hold the fluid pressure and a pressure increase control state to increase the brake fluid pressure;
a wheel speed sensing section to sense actual wheel speeds of the wheels of the vehicle;
a pseudo body speed calculating section to calculate a pseudo vehicle body speed from the wheel speeds sensed by the wheel speed sensing section;
a control target speed calculating section to calculate a control target wheel speed for a desired wheel slip rate in accordance with the pseudo vehicle body speed;
a wheel acceleration calculating section to calculate wheel accelerations of the wheels from the actual wheel speeds sensed by the wheel speed sensing section;
a pressure control section to control the brake fluid pressure for each brake cylinder in a pressure decrease control to decrease the brake fluid pressure by changing over the switch control section to the pressure decrease control state when the actual wheel speed becomes lower than the control target wheel speed, and in a pressure increase control to increase the brake fluid pressure by changing over the switch control section to the pressure increase control state when the wheel acceleration is in a predetermined region;
a left and right road surface friction coefficient estimating section to calculate each of left and right estimated road surface friction coefficients from a relation between a pressure decrease control time in one cycle and a maximum wheel acceleration during the pressure decrease time;
a split friction discriminating section to discriminate a split friction road surface condition in accordance with a difference between the left and right estimated road surface friction coefficients; and
a control modifying section to modify a brake fluid pressure control of the pressure control section to differentiate brake control characteristics for left and right wheels from each other in the case of the split friction road surface condition.

2. The brake control apparatus as claimed in claim 1, wherein the left and right road surface friction coefficient estimating section calculates the left estimated road surface friction coefficient from the relation between the pressure decrease control time and the maximum wheel acceleration of one of the wheels on a left side of the vehicle, and calculates the right estimated road surface friction coefficient from the relation between the pressure decrease control time and the maximum wheel acceleration of one of the wheels on a right side of the vehicle; and the control modifying section normally allows the pressure control section to control the brake fluid pressure for each wheel in a non-split mode, and causes the pressure control section to control the brake fluid pressure for at least one wheel on a higher friction side in a higher friction side control mode, and the brake fluid pressure for at least one wheel on a lower friction side in a lower friction side control mode in the case of the split friction road surface condition.

3. The brake control apparatus as claimed in claim 2, wherein the control modifying section modifies the brake control characteristic on the higher friction side so as to increase a pressure increase control quantity and to decrease a pressure decrease control quantity, and modifies the brake control characteristic on the lower friction side so as to decrease the pressure increase control quantity and increase the pressure decrease control quantity.

4. The brake control apparatus as claimed in claim 2, wherein the control modifying section modifies the brake control characteristics so as to increase a control gain on the higher friction side to a high value higher than a normal value and to decrease the control gain on the lower friction side to a low value lower than the normal value.

5. The brake control apparatus as claimed in claim 2, wherein the control modifying section modifies the brake control characteristics so as to increase the control target speed by a predetermined quantity on the higher friction side in the case of the split friction road surface condition.

6. The brake control apparatus as claimed in claim 1,
wherein the split friction discriminating section determines that the vehicle is in the split friction road surface condition when the difference between the left and right estimated friction coefficients is greater than a predetermined difference value; and
wherein the pressure control section controls the brake fluid pressure for each brake cylinder in the pressure decrease control by changing over the switch control unit to the pressure decrease control state when the actual wheel speed becomes lower than the control target wheel speed, and in the pressure increase control by changing over the switch control unit to the pressure increase control state when the wheel acceleration becomes smaller than zero or when the wheel acceleration becomes greater than a predetermined acceleration value.

7. The brake control apparatus as claimed in claim 1, wherein the left and right road friction coefficient estimating section calculates each of the left and right estimated road surface friction coefficients from a quotient resulting from division of the maximum wheel acceleration during the pressure decrease time, by the pressure decrease control time from a start of the pressure decrease control to a start of the pressure increase control.

8. A brake control method for an anti-skid brake system including a master cylinder to produce a brake fluid pressure, brake cylinders each to produce a braking force for one of wheels of a vehicle by receiving supply of the fluid pressure, and a switch control section to regulate a brake fluid pressure for each brake cylinder in one of a pressure decrease control state to decrease the brake fluid pressure, a pressure hold control state to hold the fluid pressure for the first brake cylinder and a pressure increase control state to increase the brake fluid pressure, the brake control method comprising:
a first step of sensing actual wheel speeds of the wheels of the vehicle;
a second step of calculating a pseudo vehicle body speed from the wheel speeds sensed by the wheel speed sensing section;
a third step of calculating a control target wheel speed to achieve a desired wheel slip rate in accordance with the pseudo vehicle body speed;
a fourth step of calculating wheel accelerations of the wheels from the actual wheel speeds sensed by the wheel speed sensing section;
a fifth step of controlling the brake fluid pressure for each brake cylinder in a pressure decrease control by changing over the switch control unit to the pressure decrease control state when the actual wheel speed becomes lower than the control target wheel speed, and in a pressure increase control by changing over the switch control unit to the pressure increase control state when the wheel acceleration is in a predetermined region;
a sixth step of calculating each of left and right estimated friction coefficients in accordance with a pressure decrease control time in one cycle and a maximum wheel acceleration during the pressure decrease time;
a seventh step of discriminating a split friction road surface condition in accordance with a difference between the left and right estimated friction coefficients; and
an eighth step of modifying a pressure control in the fifth control method element to differentiate brake control characteristics on left and right sides from each other in the case of the split friction road surface condition.

9. The brake control method as claimed in claim 8, wherein, in the fifth step, the brake fluid pressure for each wheel is controlled in a non-split mode in the absence of the split friction road surface condition, and in such a split mode to differentiate the brake control characteristics on in the presence of the split friction road surface condition, so that the brake fluid pressure for at least one wheel on a higher friction side is controlled in a higher friction side control mode, and the brake fluid pressure for at least one wheel on a lower friction side is controlled in a lower friction side control mode.

10. A vehicle comprising:
an anti-skid brake control system to control a wheel slip rate of each wheel by controlling a brake fluid pressure;
a left and right road surface friction coefficient estimating section to calculate a left estimated road surface friction coefficient from a relation between a pressure decrease control time of a left side wheel of the vehicle in one cycle and a maximum wheel acceleration of the left side wheel during the pressure decrease time, and calculate a right estimated road surface friction coefficient from a relation between a pressure decrease control time of a right side wheel of the vehicle in one cycle and a maximum wheel acceleration of the right side wheel during the pressure decrease time;
a split friction discriminating section to discriminate a split friction road surface condition in accordance with a difference between the left and right estimated road surface friction coefficients; and
a control modifying section to modify a brake fluid pressure control of the anti-skid brake control system to differentiate brake control characteristics on left and right sides of the vehicle, from each other in the case of the split friction road surface condition.
